(19) United States
(12) Patent Application Publication
(10) Pub. No.: US 2009/0232096 A1
(43) Pub. Date: Sep. 17, 2009

(54) BASE STATION, MOBILE TERMINAL, AND PROGRAM STORAGE MEDIUM

(75) Inventor: Kenichi Taniuchi, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/400,817

(22) Filed: Mar. 10, 2009

(30) Foreign Application Priority Data
Mar. 11, 2008 (JP) 2008-61396

(51) Int. Cl. H04W 84/02

(52) U.S. Cl. 370/331

(57) ABSTRACT

There is provided a base station that includes a search request receiving unit configured to receive from a mobile terminal a search request requesting search of a candidate base station for a handover target; an examination request transmitting unit configured to transmit to other base stations an examination request for checking whether or not the mobile terminal is present in the coverage areas of the other base stations when the search request has been received; an examination result receiving unit configured to receive, from the other base stations, examination result information showing whether or not the mobile terminal is present in the coverage areas of the other base stations; and a search response transmitting unit configured to identify one of the other base stations whose coverage area contains the mobile terminal as the candidate base station, and transmit, to the mobile terminal, information on the identified candidate base station.

### CROSS REFERENCE TO RELATED APPLICATIONS

This application is based upon and claims the benefit of priority from the prior Japanese Patent Applications No. 2008-61396, filed on Mar. 11, 2008; the entire contents of which are incorporated herein by reference.

### BACKGROUND OF THE INVENTION

1. Field of the Invention

The present invention relates a base station, a mobile terminal, and a program storage medium for storing communication program, and to a technique for changing a base station while reducing degradation of communication quality of a mobile terminal during handover, for example.

2. Related Art

In a wireless Local Area Network (LAN), radio condition degrades when a mobile terminal moves and physically gets away from an access point, which is a base station with which it has been establishing a connection. For this reason, the mobile terminal performs a handover for re-establishing a connection with another access point. Since wireless communication with a connected base station is once disconnected during handover, the mobile terminal cannot perform data communication in the meantime, which causes loss or delay of communication data.

Specifically, at the time of a handover, the mobile terminal makes a request for finding neighboring access points, which is called scanning, and creates a list using responses from access points that are positioned in the vicinity. The mobile terminal then selects an access point from the list and performs connection authentication to the access point to establish a connection with the new access point. However, because guarantee on success of authentication to an access point found in a search cannot obtained from the result of scanning, the mobile terminal has to sequentially attempt authentication to access points that have been found until authentication succeeds. Thus, handover time becomes longer as the number of access points found increases and ongoing communication is interrupted. When communication data is for an application that requires real-timeliness, such as VoIP and videophone communication, the usability of the application lowers because of the time required for the handover.

In IEEE802.11k, when a mobile terminal requests a connected access point for information on neighboring access points, the access point obtains a list of neighboring access points using some means and returns the result to the mobile terminal. This allows the mobile terminal to obtain a list that contains an access point a connection with which will succeed without fail and thus perform a faster handover. More specifically, the mobile terminal can select an access point connection with which will reliably succeed and whose coverage area contains the mobile terminal by creating a list of physically connectable access points which result from scanning at the time of handover and then comparing the list with a list of access points which is obtained using IEEE802.11k (for example, see

Draft Standard for Information Technology-Telecommunications and information exchange between systems—

Local and metropolitan area networks—

Specific requirements

Part 11: Wireless LAN Medium Access Control (MAC) and Physical Layer (PHY) specifications

Amendment 1: Radio Resource Measurement of Wireless LAN's

IEEE P802.11k/D12.0, January 2008

(P6, 60-63, 77-79, 102-107, 129, 134))

Even in the IEEE802.11k-based method, however, the mobile terminal conducts scanning for checking connectivity to access points, thus a handover is accordingly time-consuming and data communication is interrupted.

In a case the mobile terminal does not perform scanning, even if the mobile terminal requests connection to an access point which is obtained by IEEE802.11k, the problem of data communication interruption still occurs depending on radio condition when the mobile terminal is positioned outside the coverage area of the access point. That is, there would be an increase in handover time by the length of retransmission which is performed due to absence of a response to control data communication used for connection and/or timeout after reception wait and data communication would be interrupted in the meantime.

### SUMMARY OF THE PRESENT INVENTION

According to an aspect of the present invention, there is provided with a base station that forms a coverage area which overlaps the coverage areas of other base stations and performs communication with a mobile terminal in the coverage area, the base station comprising:

a search request receiving unit configured to receive from the mobile terminal a search request requesting search of a candidate base station for a handover target;

an examination request transmitting unit configured to transmit to the other base stations an examination request for checking whether or not the mobile terminal is present in the coverage areas of the other base stations when the search request has been received by the search request receiving unit;

an examination result receiving unit configured to receive, from the other base stations, examination result information showing whether or not the mobile terminal is present in the coverage areas of the other base stations; and

a search response transmitting unit configured to identify one of the other base stations whose coverage area contains the mobile terminal as the candidate base station, and transmit, to the mobile terminal, information on the identified candidate base station as a response to the search request.

According to an aspect of the present invention, there is provided with a mobile terminal that communicates with a base station which forms a coverage area which overlaps the coverage areas of other base stations, the mobile terminal comprising:

a search request transmitting unit configured to transmit to the base station a search request of candidate base stations for a handover target;

a search response receiving unit configured to receive from the base station a list of ones of the other base stations whose coverage area contains the mobile terminal as a response to the search request;

a handover target deciding unit configured to decide a handover target base station from among the other base stations described in the list; and

a connection request transmitting unit configured to transmit a connection request to the handover target base station.

According to an aspect of the present invention, there is provided with a program storage medium storing a computer program for causing a base station that forms a coverage area which overlaps the coverage areas of other base stations and performs communication with a mobile terminal in the coverage area, to execute instructions to perform the steps of:

receiving from the mobile terminal a search request requesting search of a candidate base station for a handover target;

transmitting to the other base stations an examination request for checking whether or not the mobile terminal is present in the coverage areas of the other base stations when the search request has been received;

receiving, from the other base stations, examination result information showing whether or not the mobile terminal is present in the coverage areas of the other base stations; and

identifying one of the other base stations whose coverage area contains the mobile terminal as the candidate base station, and transmitting, to the mobile terminal, information on the identified candidate base station as a response to the search request.

According to an aspect of the present invention, there is provided with a program storage medium storing a computer program for causing a mobile terminal that communicates with a base station which forms a coverage area which overlaps the coverage areas of other base stations, to execute instructions to perform the steps of:

transmitting to the base station a search request of candidate base stations for a handover target;

receiving from the base station a list of ones of the other base stations whose coverage area contains the mobile terminal as a response to the search request;

deciding a handover target base station from among the other base stations described in the list; and

transmitting a connection request to the handover target base station.

### BRIEF DESCRIPTION OF THE DRAWINGS

FIG. 1 generally shows the configuration of a wireless LAN base station or access point as an embodiment of the present invention;

FIG. 2 shows a protocol stack of the access point shown in FIG. 1;

FIG. 3 generally shows the configuration of a mobile terminal as an embodiment of the present invention;

FIG. 4 shows the protocol stack of the mobile terminal shown in FIG. 3;

FIG. 5 shows the configuration of a network according to an embodiment of the present invention;

FIG. 6 is a sequence chart of control signals between the mobile terminal and access points according to an embodiment of the present invention;

FIG. 7 shows an example of a neighborhood report request frame;

FIG. 8 shows an example of neighborhood data request and response frames;

FIG. 9 shows an example of a mobile terminal search request message;

FIG. 10 shows an example of a mobile terminal search response message; and

FIG. 11 shows an example of a neighborhood report response frame.

### DETAILED DESCRIPTION OF THE INVENTION

An embodiment of the present invention will be described below with reference to drawings.

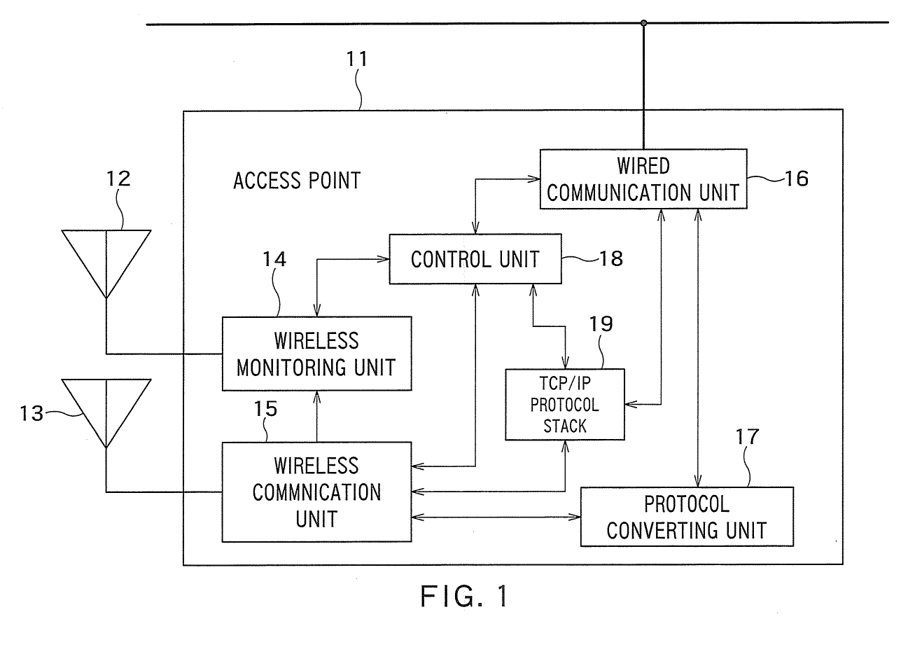

FIG. 1 shows the configuration of a base station (or access point) 11 according to an embodiment of the invention.

The access point 11 includes a wireless LAN antenna 12, a wireless LAN antenna 13, a wireless monitoring unit 14, a wireless communication unit 15, a wired communication unit 16, a protocol converting unit 17, a control unit 18, and a TCP/IP protocol stack 19.

The wireless monitoring unit 14 is provided corresponding to the antenna 12, and the wireless communication unit 15 corresponding to the antenna 13. The wireless monitoring unit 14 and wireless communication unit 15 are device drivers for a wireless LAN.

The wireless monitoring unit 14 monitors wireless data received by the antenna 12. The antenna 12 is not used for data communication but for the purpose of radio monitoring, and is activated in promiscuous mode for receiving all communication data. Thus, any received MAC frame other than ones destined for the antenna 13 is sent to the wireless monitoring unit 14.

The wireless communication unit 15 performs communication with a wireless LAN terminal (a mobile terminal) using the wireless LAN antenna 13. Communication data is called MAC frames and is communicated using IEEE802.11b, which is a communication protocol for a wireless LAN, for example. The communication protocol for a wireless LAN is implemented in the wireless communication unit 15. A UDP message received by the wireless communication unit 15 is sent to the control unit 18 via the TCP/IP protocol stack 19.

The wired communication unit 16 is a device driver for a wired LAN and performs communication with other device deployed in a wired LAN (e.g., another access point, router). A communication protocol for a wired LAN is implemented in the wired communication unit 16. A UDP message received by the wired communication unit 16 is sent to the control unit 18 via the TCP/IP protocol stack 19.

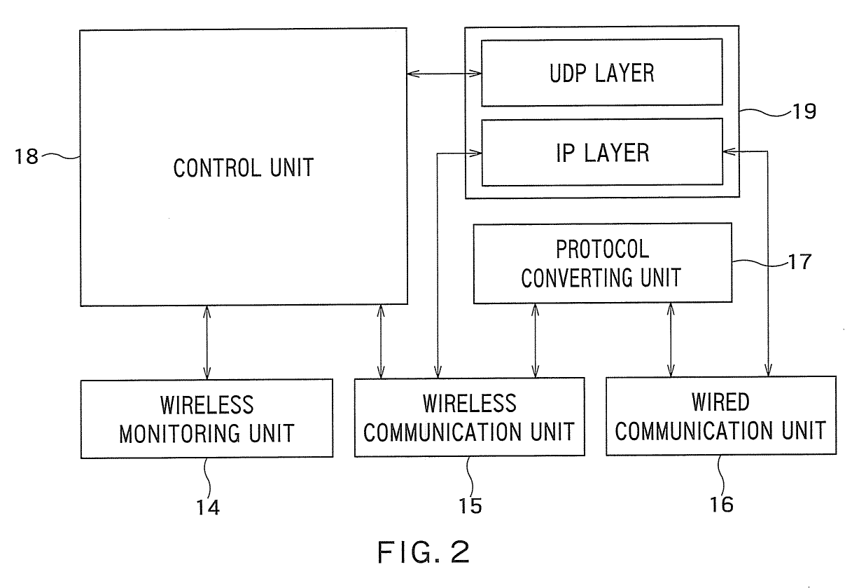

The control unit 18 performs communication with other devices (e.g., another access point, wireless LAN terminal, or router) using the wireless communication unit 15, wireless monitoring unit 14, wired communication unit 16, and TCP/IP protocol stack 19. A UDP message transmitted from the control unit 18 is sent to the wireless communication unit 15 or wired communication unit 16 via the TCP/IP protocol stack 19. The TCP/IP protocol stack 19 implements UDP and IP communication stacks like the protocol stack of the access point 11 shown in FIG. 2. The control unit 18 is responsible for reception of frames and RSSI information via the wireless monitoring unil4 as well as signal exchange with the wireless communication unit 15, and has a socket interface for UDP and the like, and creates a protocol message for finding neighboring access points through such features.

The protocol converting unit 17 receives a MAC frame from the antenna 13 via the wireless communication unit 15, converts the protocol of the MAC frame to a protocol for a wired LAN (e.g., IEEE802.3), and sends the converted MAC frame to a wired LAN by way of the wired communication unit 16, as shown in FIG. 2.

The protocol converting unit 17 also receives a MAC frame from a wired LAN via the wired communication unit 16, converts the protocol of the MAC frame to a communication protocol for a wireless LAN, and transmits the converted MAC frame from the antenna 13 via the wireless communication unit 16.

Protocol conversion between a wired LAN and a wireless LAN is defined in IEEE802.1D, which is called a bridge function. The wireless communication unit 15 and the wired communication unit 16 send their communication data to the protocol converting unit 17, thereby bridging the communication data from a wireless LAN to a wired LAN and vice versa.

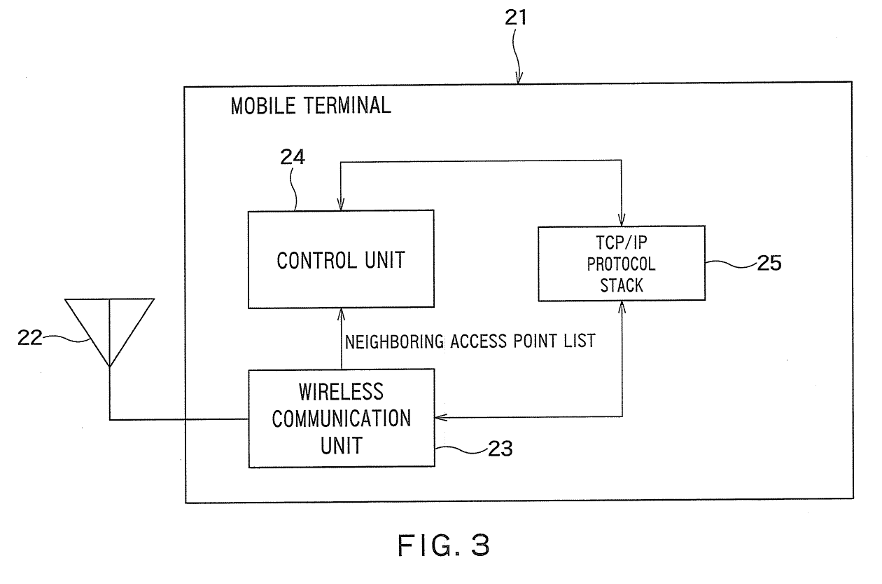

FIG. 3 shows the configuration of the wireless LAN terminal (or mobile terminal) 21 according to an embodiment of the present invention.

The mobile terminal 21 has a wireless LAN antenna 22, a wireless communication unit 23, a control unit 24, and a TCP/IP protocol stack 25.

The wireless communication unit 23 is a device driver for the antenna 22 which implements a wireless LAN protocol (e.g., IEEE802.11b) as the wireless communication unit 15 of the access point 11. A UDP message received by the wireless communication unit 23 is sent to the control unit 24 via the TCP/IP protocol stack 25, and a UDP message transmitted from the control unit 24 is sent to the wireless communication unit 23 via the TCP/IP protocol stack 25.

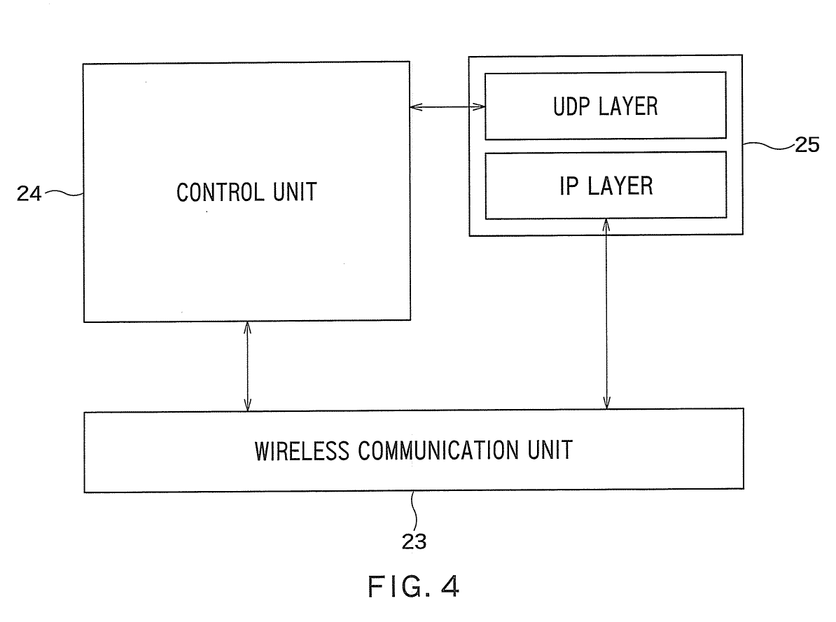

The control unit 24 performs communication with the access point 11 using the wireless communication unit 23 and the TCP/IP protocol stack 25. The TCP/IP protocol stack 25 implements UDP and IP communication stacks like the protocol stack of the mobile terminal 21 shown in FIG. 4. The control unit 24 has a socket interface for UDP or the like and exchanges signals with the wireless communication unit 23, and creates a protocol message for finding neighboring access points through such features.

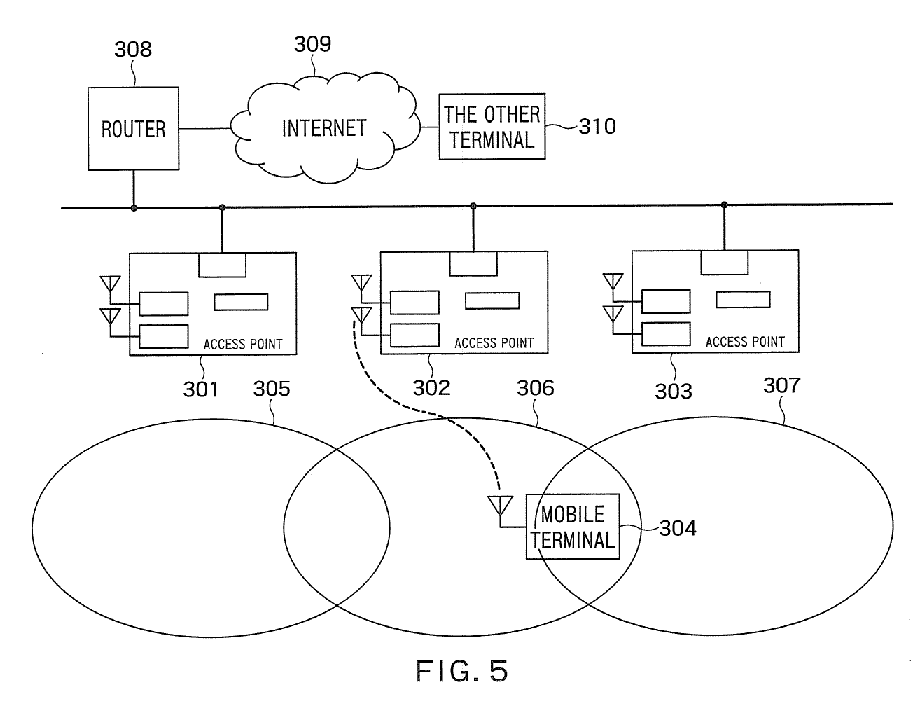

FIG. 5 shows a communication network system in which three access points 301, 302 and 303 having the configuration illustrated in FIG. 1 are connected with a mobile terminal 304 having the configuration shown in FIG. 3.

The access points 301, 302 and 303 are connected to the same subnet of a wired LAN using the wired communication unit 16. Although the access points 301, 302 and 303 are shown to be connected by wire in the present example, these access points may be wirelessly connected.

The mobile terminal 304 is connected with the access point 302 via a wireless LAN and is in communication with the access point 302 using the antenna 22.

The access points 301, 302 and 303 have a coverage area 305, 306 and 307, respectively. For the access points, different channels are set for preventing interference.

The mobile terminal 304 is in communication with the other terminal (i.e. destination terminal) 310 using Internet Protocol (IP). The figure shows that the mobile terminal 304 has moved away from the access point 302 due to traveling and covered by both the coverage areas 306 and 307. An IP packet transmitted from the mobile terminal 304 is added with a MAC frame header and transmitted using a wireless LAN. The MAC frame is received by the access point 302, goes through a router 308 via a wired LAN, and reaches the other terminal 310 via the Internet 309.

An IP packet transmitted from the other terminal 310 goes through the Internet 309 and the router 308 to be transmitted from the access point 302 to the mobile terminal 304 as payload of a wireless MAC frame. The mobile terminal 304 receives the wireless MAC frame from the access point 302 and takes the IP packet from the payload of the MAC frame.

The mobile terminal 304 measures radio field intensity, such as RSSI, with the wireless communication unit 23 based on communication data received from the access point 302.

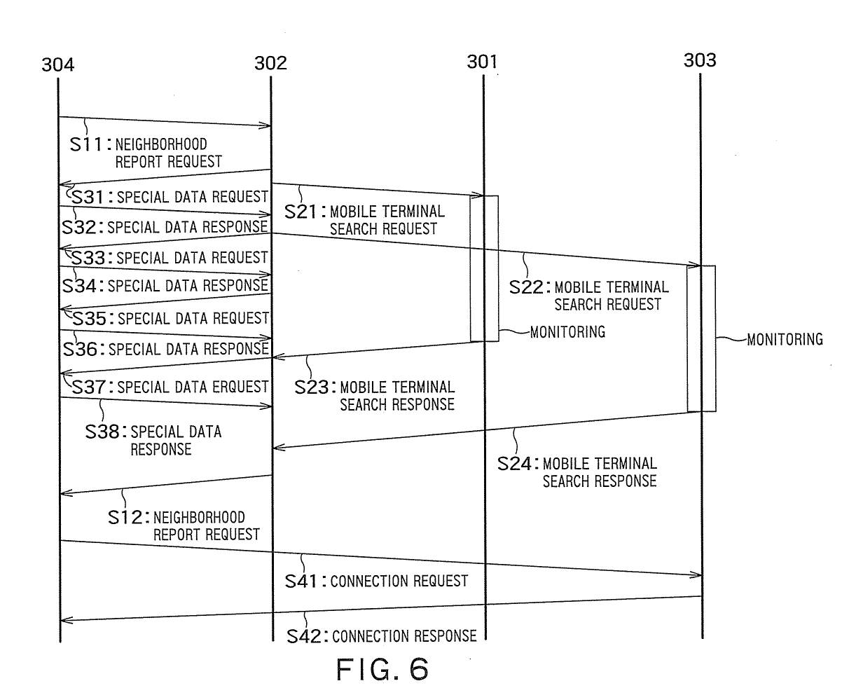

FIG. 6 is a sequence chart of control signals that are transmitted and received between the mobile terminal 304 and the access points 301 to 303.

The mobile terminal 304 detects that radio condition, such as field intensity, has degraded because the user employing the mobile terminal has moved away from the access point 302 after walking or riding on some vehicle from a result of measurement performed by the wireless communication unit 23. The mobile terminal 304 transmits a neighborhood report request frame to the access point 302 with which the mobile terminal 304 is connecting using a neighborhood report function of IEEE802.11k or IEEE802.21 in order to acquire information on neighboring access points whose coverage area contains the mobile terminal 304 (S11). Processing at step S11 on the mobile terminal 304 corresponds to processing by a search request transmitting unit or at a search request transmitting step, for example. The neighborhood report request corresponds to a search request for a candidate base station which will be a candidate for a handover target, for instance.

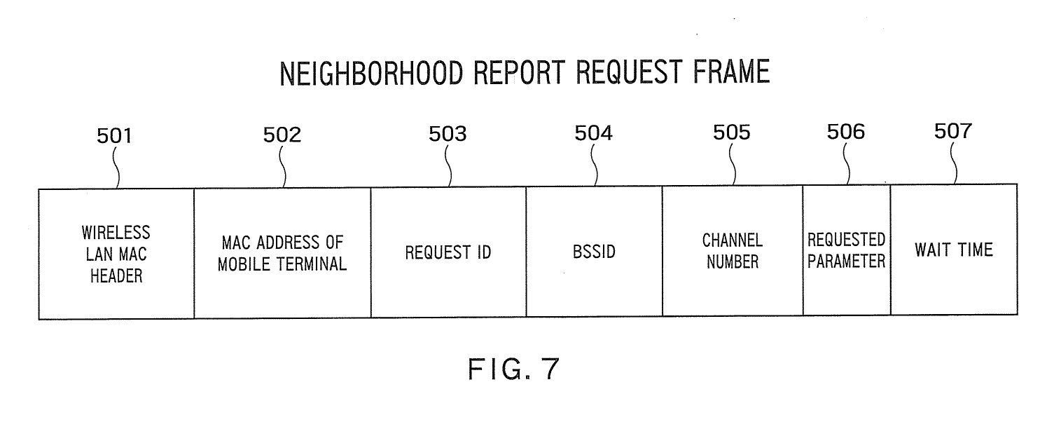

FIG. 7 shows an example of the neighborhood report request frame.

The frame starts with a wireless LAN MAC header 501. In the MAC header 501, a source MAC address, a destination MAC address, a frame type and so forth are stored. The source MAC address indicates the mobile terminal 304, the destination MAC address is the access point 302, and the MAC frame type represents a neighborhood report.

In payload of the frame, there are stored an MAC address 502 of the mobile terminal 304, a request ID 503, a BSSID 504 which is the MAC address of the access point 302, a channel number 505 of the access point 302, a requested parameter 506, and a response wait time 507.

The request ID 503 is an ID uniquely identifying a neighborhood report request frame.

The BSSID 504 is the BSSID of the access point 302.

The channel number 505 is the channel number of the access point.

The requested parameter 506 is a parameter which the mobile terminal 304 wants to acquire in order to select an access point for connection from among neighboring access points found (or a desired parameter). This example assumes that RSSI representing field intensity is selected.

The wait time 507 is an amount of time for which the mobile terminal 304 waits for a neighborhood report response. If the mobile terminal 304 has not obtained a neighborhood report request within this time, it may transmit another neighborhood report request again using a different request ID.

The access point 302 receives a neighborhood report request frame from the mobile terminal 304 (S11). Processing at step S11 on the access point 302 corresponds to processing by a search request receiving unit or at a search request receiving step. Having received the neighborhood report request frame, the access point 302 recognizes with the wireless communication unit 15 that the received frame is a neighborhood report request frame from the frame type in the MAC frame header 501, and sends the frame to the control unit 18. The control unit 18 creates and transmits mobile terminal search request messages to all access points connected to a wired LAN (here 301 and 303) based on the received neighborhood report request frame (S21 and S22). Processing at steps S21 and S22 at the access point 302 corresponds to processing by an examination request transmitting unit or at an examination request transmitting step, for example. Also, the mobile terminal search request message corresponds to an examination request for checking whether a mobile terminal is present in a coverage area or not, for example.

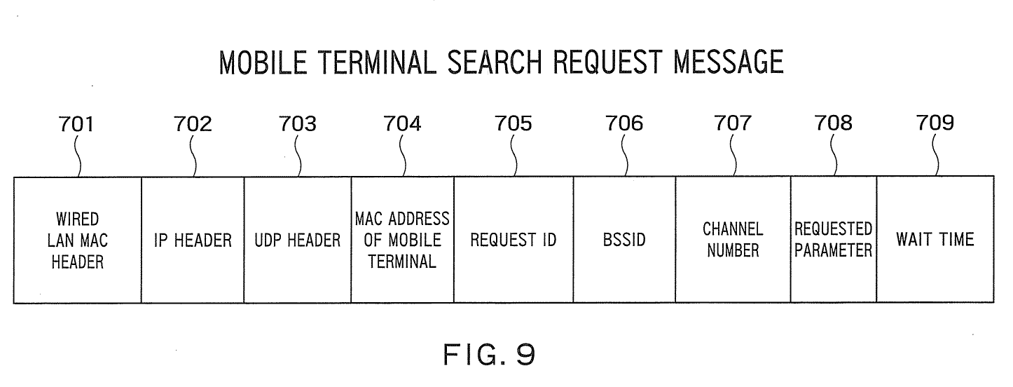

More specifically, after detecting the neighborhood report request frame based on the type in the MAC header, the wireless communication unit 15 of the access point 302 sends the payload portion (502 to 507) of the (MAC) frame to the control unit 18. The control unit 18 prepares a socket for a mobile terminal search request message and creates a mobile terminal search request message by adding a UDP header 703 and an IP header 702 to the payload portion through the TCP/IP protocol stack 19 and further adding a MAC header 701 for a wired LAN. The control unit 18 then transmits the mobile terminal search request message it created to the access points 301 and 303. An example of the mobile terminal search request message is shown in FIG. 9.

The source MAC address in the wired LAN MAC header 701 is the MAC address of a wired LAN (the MAC address of the wired communication unit 16), and the destination MAC address is a broadcast address.

The source IP address is the IP address of a wired LAN (the IP address of the access point 302), and the destination IP address is a multicast address if a multicast address representing an access point exists, and is a broadcast address otherwise.

The destination UDP port is a port dedicated for mobile terminal search request messages. Transmission is also possible when a dedicated protocol such as TCP is defined instead of UDP, but this example uses UDP.

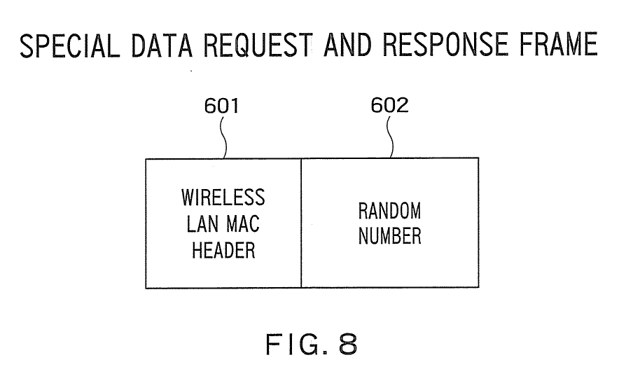

On the other hand, the control unit 18 of the access point 302 also transmits a special data request frame to the MAC address of the mobile terminal 304 when it creates and transmits the mobile terminal search request message (S31). The special data request frame corresponds to a frame transmission request for requesting transmission of a special frame, for instance, and processing at step S31 corresponds to processing by a frame transmission request transmitting unit. FIG. 8 shows an example of the special data request frame. The source MAC address in the MAC header is the MAC address of a wireless LAN of the access point 302, and the destination MAC address is the MAC address of the mobile terminal 304. Type in the MAC header is neighborhood search dedicated type. Random number is a number that is randomly changed on each transmission. A possible implementation of this is to increase the number gradually, such as 1, 2, 3 . . .

Having received the special data request frame, the mobile terminal 304 detects that it is a frame dedicated to neighborhood search from the type in the MAC header, creates a special data response frame with the wireless communication unit 23, and transmits it to the access point 304 (S32). Processing at step S32 corresponds to processing by a frame transmitting unit, for example. The special data response frame has the same format as that of the special data request frame shown in FIG. 8. However, the source MAC address in the MAC header of the special data response frame is the MAC address of the mobile terminal 304, and the destination MAC address is the MAC address for a wireless LAN of the access point 302. The random number is the same value as the one in the special data request frame received.

Exchange of such special data request frame and special data response frame is repetitively performed for the wait time 506, for example (S33 to S38).

Such exchange of special data request and response frames is performed for the purpose of forcing communication to be established between the mobile terminal 304 and the access point 302 for the wait time 506 and allowing the other access points 301 and 303 to observe frames that are exchanged in the communication. Therefore, if the mobile terminal 304 is exchanging communication data with the other terminal 310, it is not necessary to transmit a special data request frame to forcedly cause communication in such a way. The access point 302 may accordingly be implemented so as to transmit a special data request frame when the mobile terminal 302 is not exchanging communication data and not to transmit a special data request frame when the mobile terminal 302 is exchanging communication data.

The special data request frame and special data response frame may be replaced with PING. When a PING request/response message is used, the access point 302 detects an IP address from communication data from the mobile terminal 304 and maintains a table that associates the IP address with the MAC address of the mobile terminal 304. Upon receiving a neighborhood report request frame, the access point 302 makes reference to the table, starts a PIN request, and receives a PING response from the mobile terminal 304.

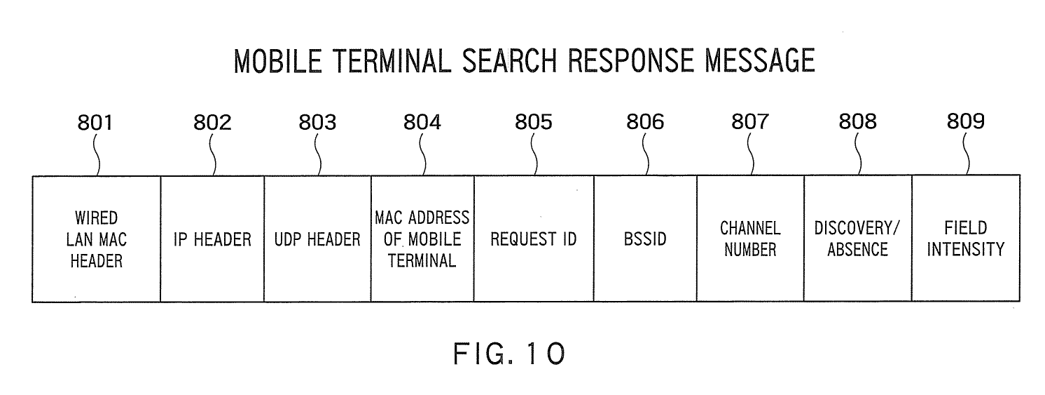

The control unit 18 of the access points 301 and 303 receives a mobile terminal search request message from the access point 302 via the wired communication unit 16 (S21 and S22). Processing at step S21 and S22 at the access points 301 and 303 corresponds to processing by an examination request receiving unit, for example. The control unit 18 of the access points 301 and 303 creates a mobile terminal search response message (see FIG. 10 discussed below) as a response to it, and returns the response message to the access point 302 (S23 and S24). Processing at S23 and S24 at the access points 301 and 303 corresponds to processing by an examination result transmitting unit, for example. In the following, operation of the access points 301 and 303 from reception of a mobile terminal search request message to transmission of a mobile terminal search response message will be described in detail.

The control unit 18 of the access points 301 and 303 analyzes the mobile terminal search request message received via the wired communication unit 16 at the IP and UDP layers and acquires UDP payload.

The control unit 18 of the access points 301 and 303 controls the wireless monitoring unit 14 using parameters written in the message. Specifically, the control unit 18 tunes the channel of the antenna 12 to the access point 302 and checks whether the mobile terminal 304 is present in the coverage area of the respective access points. This processing corresponds to that by an examining unit, for example. Specifically, the presence of the mobile terminal 304 is recognized by finding communication data that has the MAC address of the mobile terminal 304 as its source and the MAC address of the access point 302 as its destination through monitoring by the wireless monitoring unit 14. Since the wireless monitoring unit 14 is set to promiscuous mode by the control unit 18 as mentioned above, it receives all data on the channel and sends all data it receives to the control unit 18. The monitoring is performed for a fixed time. The monitoring may be terminated when communication data transmitted from the mobile terminal 304 is found. The fixed time for monitoring is calculated based on the wait time 709 in the message.

Since the mobile terminal 304 is present in the coverage area 307 (see FIG. 5), the access point 303 monitors communication between the access point 302 and the mobile terminal 304. On the other hand, the access point 301 does not monitor communication between the access point 302 and the mobile terminal 304 because the mobile terminal 304 is not present in the coverage area 305.

Communication data that can be monitored may be data being transmitted by the mobile terminal 304 to the other terminal 310 or a special data response frame being transmitted to the access point 302.

The control unit 18 of the access points 301 and 303 analyzes discovery/absence of the mobile terminal 304 and field intensity through the monitoring. Field intensity is analyzed because it is specified in the requested parameter 708 (see FIG. 9). That is, a request for measuring field intensity (a request for measuring a desired parameter) is contained in the mobile terminal search request message. When the control unit 18 detects transmitted data from the mobile terminal 304, it creates payload (examination result information) of a mobile terminal search response message, and transmits the mobile terminal search response message from UDP layer to the access point 302 using the wired communication unit 16.

FIG. 10 shows an example of the mobile terminal search response message.

The source MAC address in a wired LAN MAC header 801 is the MAC address of the wired LANs of the access points 301 and 303. The destination MAC address is the MAC address of the wired LAN of the access point 302.

The source IP address in an IP header 802 is the IP address of the wired LANs of the access points 301 and 303, and the destination IP address is the IP address of the wired LAN of the access point 302.

Port number in a UDP header 803 is a port number dedicated to mobile terminal search response messages.

Request ID 805 is a number that has the same value as the request ID 905 of the mobile terminal search request message (see FIG. 9). The request ID 805 is used for distinction from other mobile terminal search request messages.

BSSID 806 is the BSSID of the wireless communication unit 15 of the access points 301 and 303.

Channel number 807 is the channel number of the access point 301 or 303.

Discovery/absence 808 is a flag indicating whether a mobile terminal has been found, represented by 1 when one has been found and by 0 when none has been found, for example. In the present example, the value of the flag is 0 at the access point 301 as the mobile terminal 304 has not been found, whereas the value of the flag is set to 1 at the access point 303 as the mobile terminal 304 has been found.

Field intensity 809 is the field intensity of a frame as of when the mobile terminal 304 is detected. It is also possible to adopt an average field intensity of frames when a number of frames are detected.

The control unit 18 of the access points 302 receives mobile terminal search response messages from the access points 301 and 303 via the wired communication unit 16 through a socket during a fixed time (S23 and S24). Processing at steps S23 and S24 at the access point 302 corresponds to processing by an examination result receiving unit or at an examination result receiving step.

The fixed time refers to the length of a wait time described in a neighborhood report request frame (see FIG. 7) that is counted from transmission of a mobile terminal search request message. When the access point 302 has information on neighboring access points, it can wait for all responses because it can determine whether all of the neighboring access points have responded. When the access point 302 does not have information on neighboring access points, a neighboring access point which has not found mobile terminal may not respond to the mobile terminal search request message. In such a situation, the discovery/absence field 808 (see FIG. 10) which was illustrated above is not necessary and only a neighboring access point which has found a mobile terminal has to transmit the mobile terminal search response message.

The control unit 18 of the access point 302 creates payload of a neighborhood report response frame based on the mobile terminal search response message received through a socket, and sends the payload to the wireless communication unit 15. The wireless communication unit 15 adds a MAC header to the payload it received to create a neighborhood report response frame, and transmits the frame to the mobile terminal 304 via the antenna 13 (S12). Processing at step S12 at the access point 302 corresponds to processing by a search response transmitting unit or at a search response transmitting step, for example.

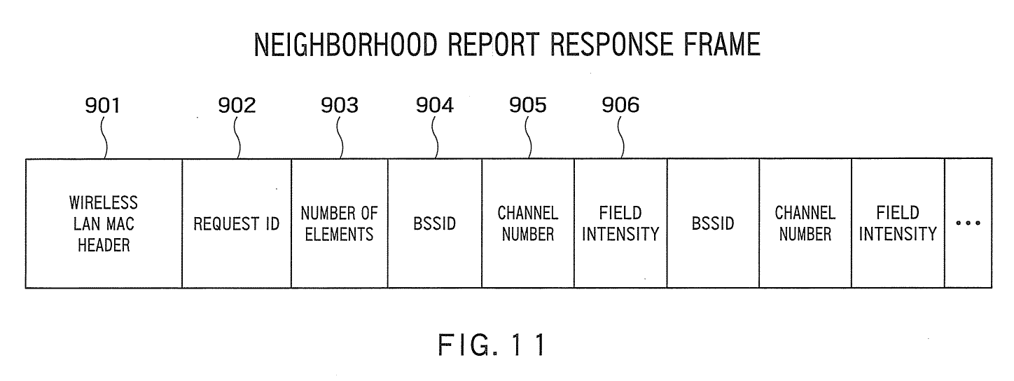

FIG. 11 shows an example of the neighborhood report response frame.

The source MAC address in a wireless LAN MAC header 901 is the MAC address of the wireless LAN of the access point 302, and the destination MAC address is the MAC address of the mobile terminal 304. The MAC address of the mobile terminal 304 can be obtained from the payload of a mobile terminal search response message.

A frame type in the MAC header 901 is the value of a type that represents neighborhood report.

Request ID 902 has the same value as one in the neighborhood report request frame.

The number of elements 903 is the number of access points which found the mobile terminal 304 and transmitted a mobile terminal search response message. Following the number of elements 903, elements as many as indicated by the number of elements 903 that include BSSID, channel number and field intensity are added. A set of these elements represents an access point list.

BSSID 904 is the BSSID of the first access point in the access point list.

Channel number 905 is the channel number of the first access point in the access point list.

Field intensity 906 is the field intensity, such as RSSI, of the first access point in the access point list.

When the number of elements 903 is one, the frame ends here, but when the number of elements is two or more, elements including BSSID, channel number, and field intensity are repeated.

When the number of elements 903 is zero, BSSID, channel number and field intensity are not added. This indicates that no neighboring access point has found a mobile terminal.

In the network of the present example, a neighborhood report response frame including the MAC address (BSSID), channel number, and field intensity of the access point 303 which has found the mobile terminal 304 is transmitted to the terminal 304.

The wireless communication unit 23 of the mobile terminal 304 receives the neighborhood report response frame from the access point (S12). The mobile terminal 302 detects that the received frame is a neighborhood report response frame from the frame type in the MAC header of the frame, and sends the payload of the neighborhood report response frame to the control unit 24. Processing at step S12 at the mobile terminal 304 corresponds to processing by a search response receiving unit or at a search response receiving step, for instance. The neighborhood report response corresponds to a search response, for example.

The control unit 24 selects an access point having the highest field intensity in an access point list obtained from the payload. When the elements in the access point list are sorted in descending order of field intensity, the first access point is selected. Processing for selecting an access point corresponds to processing by a handover target deciding unit or at a handover target deciding step.

While the present example selects the access point based on field intensity, this selection may be based on other parameter. Other parameter could be obtained by describing the parameter in the requested parameter 506 (see FIG. 7) in the neighborhood report request frame. Other parameter may be the speed or degree of congestion of a wireless LAN, for example. Since the access point 303 is the only element in the access point list in the present example, the access point 303 is selected.

Since the mobile terminal 304 is guaranteed to be positioned in the coverage 307 of the access point 303, the control unit 24 of the mobile terminal 304 makes a connection request to the access point 303 without scanning (S41). Processing at step S41 corresponds to processing by a connection request transmitting unit or at a connection request transmitting step. The wireless communication unit 23 of the mobile terminal 304 starts connection with the access point 303 by a wireless LAN protocol.

The access point 303 makes a connection response (S42) to complete connection tasks, which allows the mobile terminal 304 to change an access point.

Even if pre-authentication function of IEEE802.11i or high-speed handover capability of IEEE802.11r is implemented in this network, those functions are carried out independently because the present invention is independent from those functions.

As has been described above, according to the present embodiment, a mobile terminal can change a base station at the time of a handover without instantaneous interruption of communication associated with scanning. Therefore, it is possible to reduce loss and delay of communication data packets that result from handover of a mobile terminal.

The access point (base station) and the wireless LAN terminal (mobile terminal) in the above-described embodiment may also be realized by using a generic computer device as basic hardware, for example. That is, the control unit, wireless monitoring unit, wireless communication unit, wired communication unit, protocol converting unit, and TCP/IP protocol stack of the base station, and the control unit, wireless communication unit, and TCP/IP protocol stack of the mobile terminal can be realized by causing a processor included in such a computer device to execute a program. In this case, the base station and the mobile terminal may be realized by installing the program in the computer device in advance or storing the program in a storage medium (program storage medium) such as a CD-ROM or distributing the program over a network to appropriately install the program in the computer device.

What is claimed is:

1. A base station that forms a coverage area which overlaps coverage areas of other base stations and performs communication with a mobile terminal in the coverage area, comprising:
a search request receiving unit configured to receive from the mobile terminal a search request requesting search of a candidate base station for a handover target;
an examination request transmitting unit configured to transmit to the other base stations an examination request for checking whether or not the mobile terminal is present in the coverage areas of the other base stations when the search request has been received by the search request receiving unit;
an examination result receiving unit configured to receive, from the other base stations, examination result information showing whether or not the mobile terminal is present in the coverage areas of the other base stations; and
a search response transmitting unit configured to identify one of the other base stations whose coverage area contains the mobile terminal as the candidate base station, and transmit, to the mobile terminal, information on the identified candidate base station as a response to the search request.

2. The base station according to claim 1, wherein
the examination request transmitting unit further transmits a measurement request of a desired parameter relating to the mobile terminal to the other base stations,
the examination result receiving unit further receives measured values of the desired parameter from the other base stations, and
the search response transmitting unit further transmits the measured value received from the identified candidate base station to the mobile terminal.

3. The base station according to claim 1, further comprising:
an examination request receiving unit configured to receive, from a second base station which is one of the other base stations, an examination request for checking whether or not a second mobile terminal with which the second base station is communicating is present in the coverage area;
an examining unit configured to examine whether or not the second mobile terminal is present in the coverage area; and
an examination result transmitting unit configured to transmit examination result information showing whether or not the second mobile terminal is present in the coverage area to the second base station.

4. The base station according to claim 3, wherein
the examination request receiving unit further receives channel number information which describes a channel number used by the second base station for communication with the second mobile terminal, and
the examining unit monitors a channel corresponding to the channel number described in the channel number information, and determines that the second mobile terminal is present in the coverage area when a frame that has the second mobile terminal as a source address has been detected on the channel being monitored.

5. The base station according to claim 4, wherein
the examination request receiving unit further receives from the second base station a measurement request of a desired parameter in relation to the second terminal,
the examining unit measures the desired parameter based on a detected frame that has the second mobile terminal as the source address, and
the examination result transmitting unit transmits the measured value of the desired parameter to the second base station.

6. The base station according to claim 1, further comprising
a frame transmission request transmitting unit configured to transmit to the mobile terminal a frame transmission request for requesting transmission of a special frame that has an address of the mobile terminal as the source address after the examination request transmitting unit transmits the examination request to the other base stations.

7. A mobile terminal that communicates with a base station which forms a coverage area which overlaps the coverage areas of other base stations, the mobile terminal comprising:
a search request transmitting unit configured to transmit to the base station a search request of candidate base stations for a handover target;
a search response receiving unit configured to receive from the base station a list of ones of the other base stations whose coverage area contains the mobile terminal as a response to the search request;
a handover target deciding unit configured to decide a handover target base station from among the other base stations described in the list; and
a connection request transmitting unit configured to transmit a connection request to the handover target base station.

8. The terminal according to claim 7, further comprising
a frame transmitting unit configured to transmit a frame addressed to the base station, that has the mobile terminal as a source address, wherein
the search response receiving unit further receives, via the base station, values of a desired parameter measured based on the frame by the ones of the other base stations whose coverage area contains the mobile terminal; and
the handover target deciding unit decides a handover target base station from among the candidate base stations based on the measured values of the desired parameter.

9. A program storage medium storing a computer program for causing a base station that forms a coverage area which overlaps the coverage areas of other base stations and performs communication with a mobile terminal in the coverage area, to execute instructions to perform the steps of:
receiving from the mobile terminal a search request requesting search of a candidate base station for a handover target;
transmitting to the other base stations an examination request for checking whether or not the mobile terminal is present in the coverage areas of the other base stations when the search request has been received;
receiving, from the other base stations, examination result information showing whether or not the mobile terminal is present in the coverage areas of the other base stations; and
identifying one of the other base stations whose coverage area contains the mobile terminal as the candidate base station, and transmitting, to the mobile terminal, information on the identified candidate base station as a response to the search request.

10. A program storage medium storing a computer program for causing a mobile terminal that communicates with a base station which forms a coverage area which overlaps the coverage areas of other base stations, to execute instructions to perform the steps of:
transmitting to the base station a search request of candidate base stations for a handover target;
receiving from the base station a list of ones of the other base stations whose coverage area contains the mobile terminal as a response to the search request;
deciding a handover target base station from among the other base stations described in the list; and
transmitting a connection request to the handover target base station.
